(19) United States
(12) Patent Application Publication
(10) Pub. No.: US 2016/0064172 A1
(43) Pub. Date: Mar. 3, 2016

(54) PLUNGER SWITCH ASSEMBLY AND METHOD OF OPERATION

(71) Applicant: DELTA SYSTEMS, INC., Streetsboro, OH (US)

(72) Inventors: ISAAC KIRBAWY, Tallmadge, OH (US); Matthew Schwenning, Richfield, OH (US)

(21) Appl. No.: 14/838,998

(22) Filed: Aug. 28, 2015

Related U.S. Application Data
(60) Provisional application No. 62/044,562, filed on Sep. 2, 2014.

(51) Int. Cl. H01H 36/00; H01H 50/16

(52) U.S. Cl. CPC H01H 36/008; H01H 36/0073; H01H 50/16

(57) ABSTRACT

A switch assembly has a housing with a passage extending along a longitudinal axis. A plunger positioned within the passage is movable along the axis relative to the housing between an extended position protruding a first axial distance out of the housing and a depressed position protruding a second axial distance out of the housing less than the first distance. A magnetic biasing device biases the plunger towards the extended position. The magnetic biasing device includes a first magnetic member secured to the housing and a second magnetic member secured to the plunger and movable with the plunger relative to the first magnetic member. An electrical component positioned within the passage has a pair of terminal members and a sensor.

### CROSS REFERENCES TO RELATED APPLICATIONS

The following application claims priority to co-pending U.S. Provisional Patent Application Ser. No. 62/044,562 filed Sep. 2, 2014 entitled PLUNGER SWITCH ASSEMBLY AND METHOD OF OPERATION. The above-identified application is incorporated herein by reference in its entirety for all purposes.

### FIELD OF THE DISCLOSURE

Use present disclosure relates to a plunger switch assembly and method of operation arid more specifically, relates to a plunger switch assembly and method of operation for use in connection with power equipment.

### BACKGROUND

Electrical switches using push button or plunger type switch actuators have many applications including use in automobile car doors, ignition circuits, power take-offs for lawn mowers and garden tractors, refrigerator doors, home appliances, and the like, hereinafter “power equipment”. These push buttons may be normally open, normally closed or a combination of the two.

It is possible to construct switches having two or more terminals, which combine the features of normally open and normally closed switches. For example, a “double-pole double-throw” switch behaves as a normally open switch and a normally closed switch in parallel operated by a single plunger. When the plunger is in a normal position, a pair of normally closed terminals is bridged and a pair of normally open terminals is isolated. Alternatively, when the plunger is moved to an actuated position, the normally open terminals are bridged and the normally closed terminals are isolated. A “single-pole double-throw” switch behaves like a double-pole double-throw switch in which one of the normally open terminals is coupled to one of the normally closed terminals. When the plunger is in the normal position, a common terminal is bridged with a normally closed terminal while a normally open terminal is isolated. Alternatively, when the plunger is in the actuated position, the common terminal is bridged with the normally open terminal while the normally closed terminal is isolated.

Plunger switches are suitable for numerous objectives when used with

power equipment. Such objectives include, but are not limited to, safety tether switch, boat trim switch, boat throttle neutral switch, off-road utility brake light switch, back-up light switch, E-stop switch, power take off enable/disable switch, and sense position switches.

Further discussion relating to the different switch constructions can be found in U.S. Pat. No. 5,528,007 entitled PLUNGER SWITCH AND METHOD OF MANUFACTURE that issued on Jun. 18, 1996 and assigned to the assignee of the present disclosure. U.S. Pat. No. 5,528,007 is incorporated herein by reference in its entirety.

### SUMMARY

One aspect of the present disclosure includes a switch assembly having a housing with a passage extending along a longitudinal axis. A plunger positioned within the passage is movable along the axis relative to the housing between an extended position protruding a first axial distance out of the housing and a depressed position protruding a second axial distance out of the housing less than the first distance. A magnetic biasing device biases the plunger towards the extended position. The magnetic biasing device includes a first magnetic member secured to the housing and a second magnetic member secured to the plunger and movable with the plunger relative to the first magnetic member. An electrical component positioned within the passage has a pair of terminal members and a sensor. Movement of the plunger to the extended position places the sensor in an unactuated condition preventing electricity from flowing between the terminal members. Movement of the plunger to the depressed position places the sensor in an actuated condition electrically connecting the terminals to each other.

Another aspect of the present invention includes a switch assembly having a housing with a passage extending along a longitudinal axis. A plunger is positioned within the passage and movable along the axis relative to the housing between an extended position protruding a first axial distance out of the housing and a depressed position protruding a second axial distance out of the housing less than the first distance. A magnetic biasing device biases the plunger towards the extended position. The magnetic biasing device includes a first magnetic member secured to the housing and a second magnetic member secured to the plunger and movable with the plunger within and relative to the first magnetic member. An electrical component is positioned within the passage and has a pair of terminal members and a sensor. Movement of the plunger to the extended position places the sensor in an unactuated condition to change the state of electricity from one of an open and a closed condition between the terminal members. Movement of the plunger to the depressed position placing the sensor in an actuated condition to change the state of electricity from the other of an open and a closed condition between the terminals. The sensor switches between the actuated condition and the unactuated condition in response to the magnetic field of the second magnetic member.

Another aspect of the present invention includes a method for operating a switch assembly that includes providing a housing having a passage extending along a longitudinal axis. A plunger is positioned within the passage, the plunger being movable along the axis relative to the housing between an extended position protruding a first axial distance out of the housing and a depressed position protruding a second axial distance out of the housing less than the first distance. A magnetic biasing device is positioned within the passage for biasing the plunger towards the extended position, the magnetic biasing device including a first magnetic member secured to the housing and a second magnetic member secured to the plunger and movable with the plunger relative to the first magnetic member. An electrical component is positioned within the passage, the electrical component having a pair of terminal members and a sensor, movement of the plunger to the extended position placing the sensor in an unactuated condition to change the state of electricity from one of an open and a closed condition between the terminal members, movement of the plunger to the depressed position placing the sensor in an actuated condition to change the state of electricity from the other of an open and a closed condition between the terminals. The plunger is depressed towards the electrical component against the bias of the magnetic biasing device to place the sensor in the actuated condition.

### BRIEF DESCRIPTION OF THE SEVERAL VIEWS OF THE DRAWINGS

The foregoing and other features and advantages of the present disclosure will become apparent to one skilled in the art to which the present disclosure relates upon consideration of the following description of the disclosure with reference to the accompanying drawings, wherein like reference numerals, unless otherwise described refer to like parts throughout the drawings and in which:

FIG. 1 is an assembly view of a switch assembly constructed in accordance with one example embodiment of the present disclosure.

FIG. 2 is a perspective bottom view of FIG. 1.

FIG. 3 is a section view of FIG. 1 taken along section line 3-3.

FIG. 4A is a perspective view of a housing of the switch assembly of FIG. 1.

FIG. 4B is a section view of FIG. 4A taken along line 4B-4B.

FIG. 5 is an exploded assembly view of components of the switch assembly of FIG. 1.

FIG. 6A is a perspective view of a plunger of FIG. 5.

FIG. 6B is a bottom view of FIG. 6A.

FIG. 6C is a section view of FIG. 6A fakers along line 6C-6C.

FIG. 7A is a perspective view of an electrical component of FIG. 5.

FIG. 7B is a bottom view of FIG. 7A.

FIG. 8 is a perspective view of a circuit board of the electrical component of FIG. 5.

FIG. 9 is a section view of FIG. 1 with a plunger in a depressed condition, thus changing the electrical state of the switch electrically connecting terminal members together.

Skilled artisans will appreciate that elements in the figures are illustrated for simplicity and clarity and have not necessarily been drawn to scale. For example, the dimensions of some of the elements in the figures may be exaggerated relative to other elements to help to Improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Referring now to the figures generally wherein like numbered features shown therein refer to like elements having similar characteristics and operational properties throughout unless otherwise noted. The present disclosure relates to a plunger switch assembly and method of operation and more specifically, relates to a plunger switch assembly and method of operation for use in connection with power equipment.

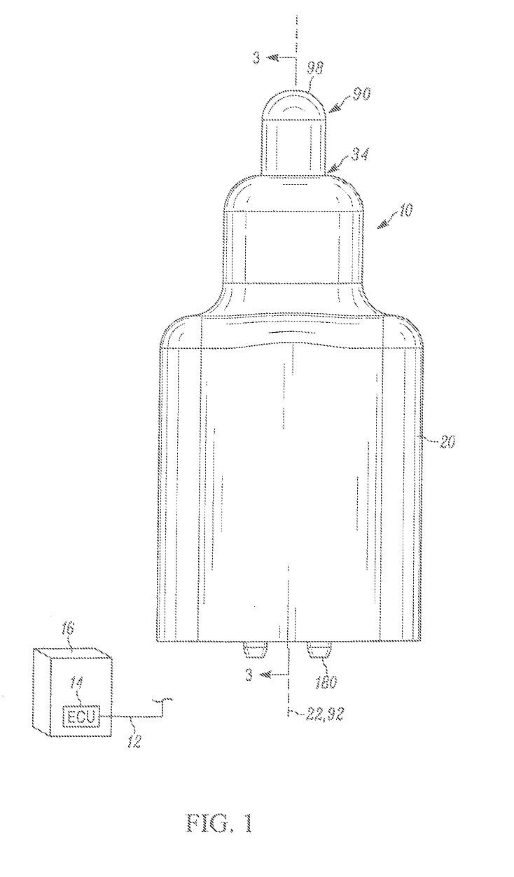

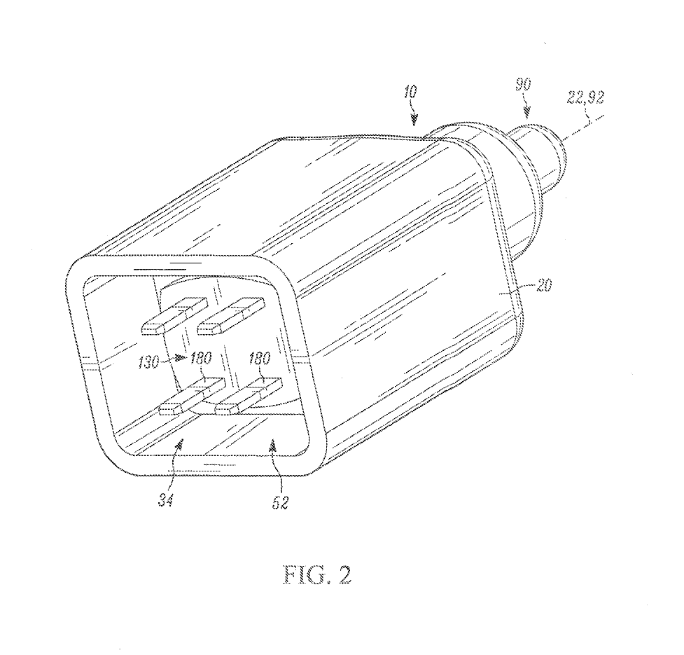

Illustrated in FIGS. 1-9 is a switch assembly 10 constructed in accordance with one example embodiment of the present disclosure. The switch assembly 10 includes a housing 20, plunger 90, biasing device 150, and an electrical component 80, including one or more terminal members 180. The plunger 90 is movable relative to the housing 20 to selectively close an electric circuit through the switch assembly 10 and place the terminal members 180 in electrical connection with one another such that electricity may pass therebetween.

The housing 20 protects the Internal components of the switch assembly 10 from the environment in the illustrated example embodiment, the housing 20 is formed from molded plastic. The housing 20 may be formed from one part or multiple parts. In one example (not shown), the housing has a first portion for enclosing the plunger 90 and a second portion for enclosing the portion(s) of the electrical component 80. The portions of the housing 20 may be releasably secured to one another or may be integrally formed together with a dividing wall between the portions to separate the components therein. In any case, the housing 20 may be configured to keep portions of the switch assembly 10 environmentally isolated from one another.

The housing 20 provides mounting features not only for the plunger 90 and electrical component 80, but other internal components and external components, such as a wiring harness 12. The wiring harness 12 communicates with an electronic control unit (ECU) 14 for the operation of power equipment 16, examples of which are listed above. In an alternative example embodiment the wiring harness 12 communicates directly to the power equipment 16 or, more specifically, communicates with an engine or other components in which the switch assembly 10 is coupled.

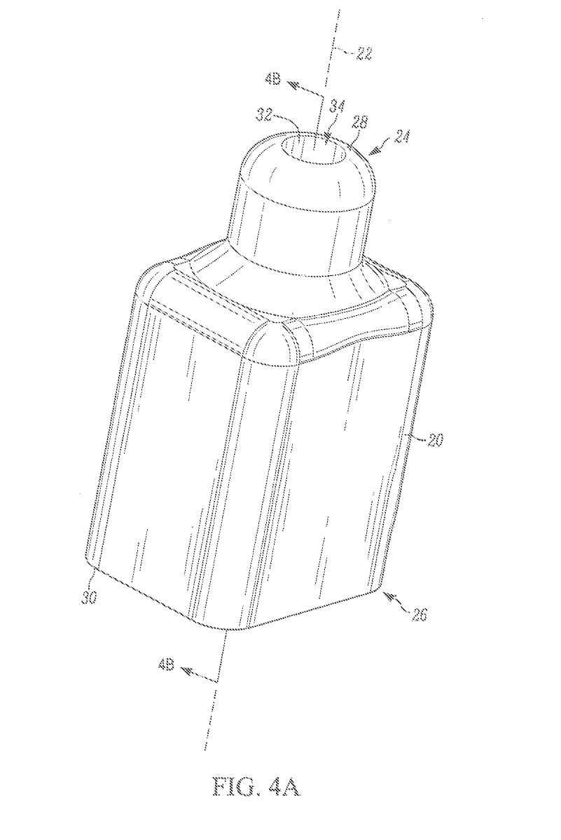

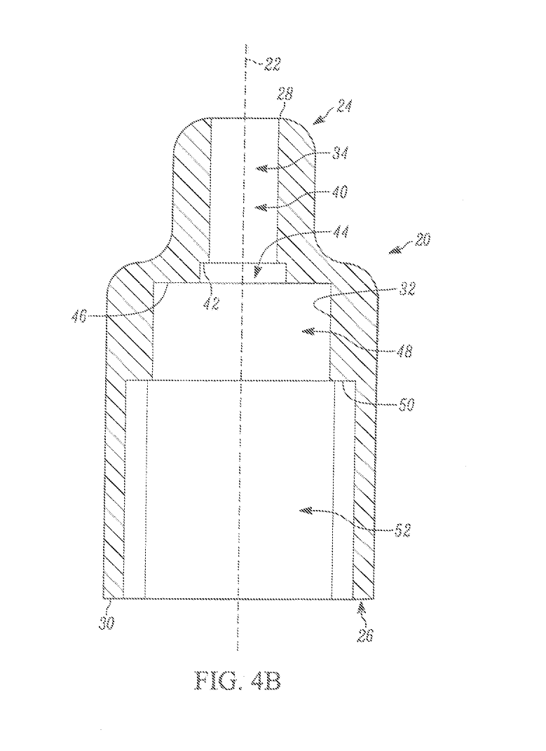

Referring to FIGS. 4A and 4B, the housing 20 extends along an axis 22 from a first end 24 to a second end 26. The first end 24 terminates an axial end surface 28 and the second end 26 terminates at an axial end surface 30. An inner surface 32 extends through the housing 20 from the end surface 28 to the end surface 30 and defines a passage 34. The passage 34 is generally centered about the axis 22 and includes a series of portions 40, 44, 48, 52 having different axial cross-sections. In one example, the portions 40, 44, 48, 52 are circular In axial cross-section and increase in diameter from the first end 24 of the housing 20 to the second end 26.

More specifically, the passage 34 includes a first portion 40 having a first diameter and extending from the end surface 28 at the first end 24 to an end surface 42 closer to the second end 26. A second portion 44 extends from the end surface 42 to an end surface 46 closer to the second end 26. The second portion 44 has a second diameter greater than the first diameter. A third portion 48 extends from the end surface 46 to an end surface 50 closer to the second end 26. The third portion 48 has a third diameter greater than the second diameter. A fourth portion 52 extends from the end surface 50 to the end surface 30 at the second end 26. The fourth portion 52 has a fourth diameter greater than the third diameter.

Is one example, the housing 20 may include a number of projections or inclusions (not shown) molded as part of the housing. The projections or inclusions allow for attachment to a mating panel (not shown) of the power equipment 16. The power equipment 16 may also have mounting holes, locking ramps, threaded features, or any combination thereof for the attachment of the switch assembly 10. The switch assembly 10 can be further attached with various fasteners, rivets, pins, and the like such that the switch assembly will not move or deflect during operation.

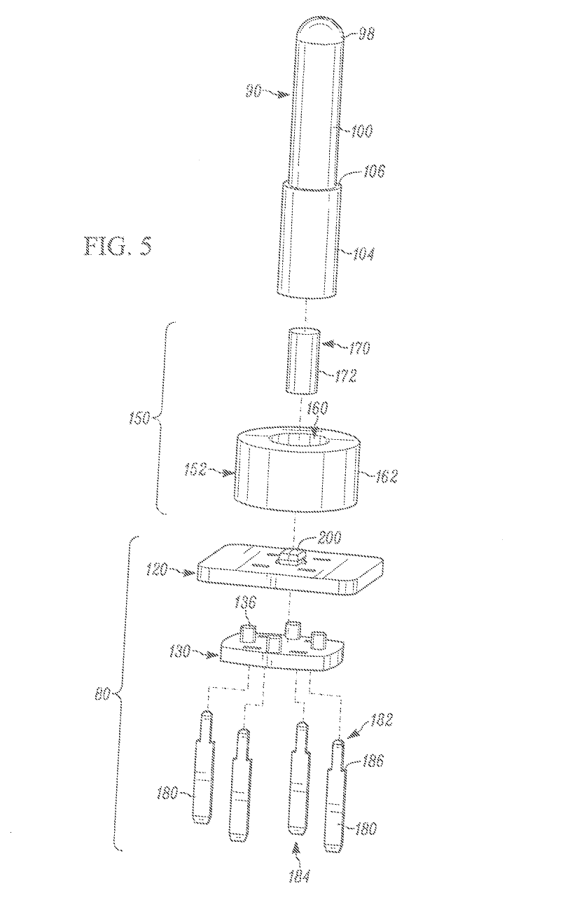

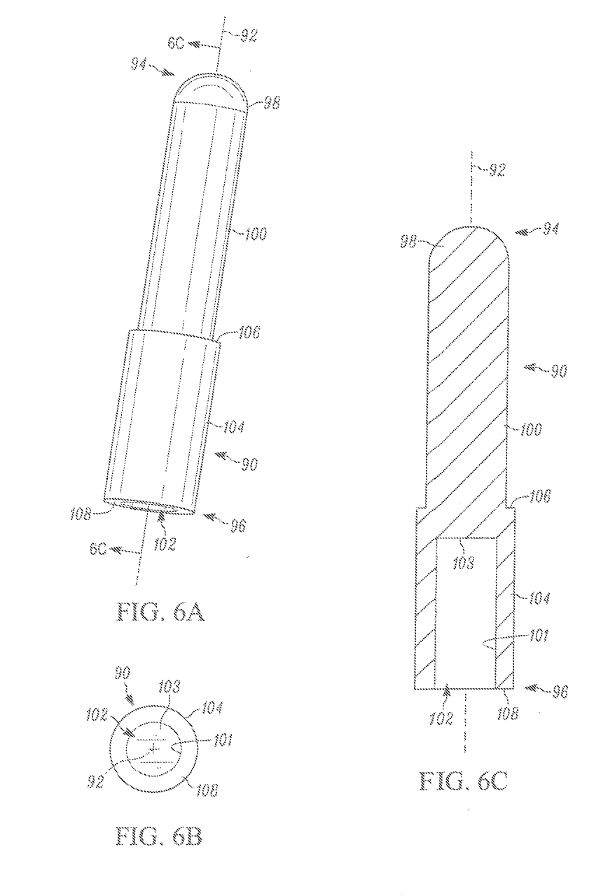

Referring to FIGS. 5-6C, the plunger 90 has a generally cylindrical shape and extends along an axis 92 from a first end 94 to a second end 94. The plunger 90 includes a rounded or hemispherical head 98 at the first end 94 and a body 100 extending from the head to the second end 96. The body 100 terminates at an end surface 108. An inner surface 101 extends within the body 96 and defines a passage 102 extending axially from an end surface 103 to the end surface 108. The passage 102 may have a circular or polygonal cross-section and extends along the axis 92. A flange 104 extends radially outward from the body 100. The flange 104 extends axially from the end surface 108 at the second end 96 to a surface 106 closer to the first end 94. The flange 104 has a circular cross-section and is centered about the axis 92. The flange 104 is sized to be slidably received in the second portion 44 of the passage 34 in the housing 20.

Referring to FIG. 5, the biasing device 150 is magnetic and includes a first member 152 and a second member 170. Either the first member 152 or the second member 170 may be a permanent magnet, electromagnet or formed from a ferrous material. One of the first and second members 152, 170 may have an active magnetic field and the other member may either have an active magnetic field or be formed from ferrous material. In one example, the first member 152 is a ring-shaped magnet having a circular outer surface 162, although other shapes are contemplated. A passage 160 extends entirely through the first member 152. The passage 160 has a circular shape but may alternatively have a polygonal shape. In any ease, the passage 160 is sized and shaped to slidably receive the flange 104 of the plunger 90.

The first member 152 is secured to the housing 20 within the passage 34. More specifically, the first member 152 is positioned within the third portion 48 of the passage 34 in the housing 20 such that the first member abuts or is adjacent to the end surface 46. This places the outer surface 162 of the first member adjacent to the inner surface 32 of the housing 20. The first member 152 may be secured to the housing 20 in this position using fasteners, adhesive or the like.

The second member 170 is a cylindrical magnet having a circular outer surface 172, although other shapes are contemplated. The second member 170 is positioned within the passage 102 of the plunger 90 and may abut the end surface 103 (see FIG. 6C) or be spaced from the end surface (not shown). The second member 170 may he secured to the plunger 90 using fasteners, adhesive or the like. In any case, the second member 170 is rigidly secured to the plunger 90 so as to be movable therewith.

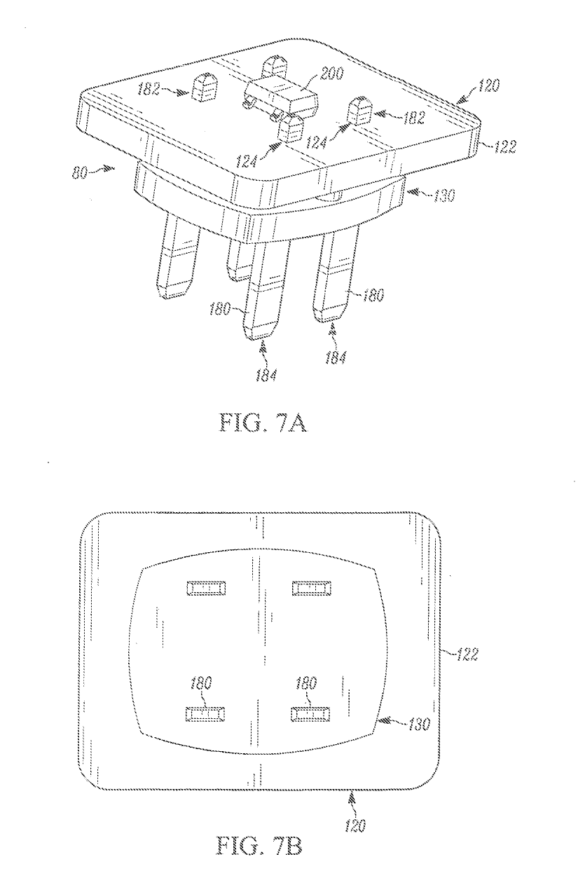

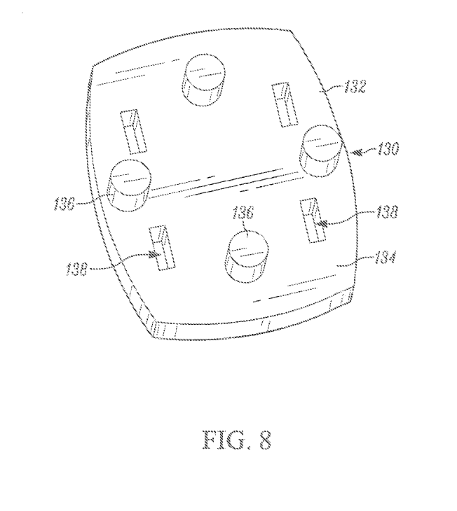

Referring to FIGS. 7A-8, the electronic component 80 includes a pair of circuit boards 120, 130, a plurality of terminal members 180, and a sensor 200. Although four terminal members 180 are illustrated it will he understood that the electrical component 80 may include more or fewer terminal members. The circuit board 120 has a rectangular shape and includes an outer, peripheral surface 122. The circuit board 120 includes electrical components configured to receive, store, process, and relay electrical signals for operating the power equipment 16 via the wiring harness 12 (see FIG. 1). A plurality of openings 124 corresponding with the number of terminal members 180 extends through the circuit board 120 for receiving the terminal members. In one example, the openings 124 are symmetrically arranged about the center of the circuit board 120, although other configurations are contemplated.

A switch or sensor 200 is secured to and electrically connected with the circuit board 120 and the terminal members 180. In one example, the sensor 200 is secured to the center of the upper surface of the circuit board 120. The sensor 200 may constitute a transducer used for proximity switching, e.g., a Hall effect sensor or Reed switch. The sensor 200 may have a normally open or normally closed configuration. To this end, the sensor 200 may be configured to be actuated (switched one of on or off) when a magnet moves within a predetermined distance from the sensor and be unactuated (switched to the other of on or off) when the magnet is beyond the predetermined distance from the sensor. In the illustrated embodiment, the sensor 200 has a normally open configuration and is actuated to close the circuit and allow electricity to pass therethrough.

Referring to FIG. 8, the circuit board 130 is electrically connected to the circuit board 120, the terminal members 180, and the sensor 200. The circuit board 130 includes a base 132 and a series of projections 136 extending from the base. The base 132 has a generally rectangular shape. A plurality of openings 138 corresponding with the number of terminal members 180 extends through the circuit board 130 for receiving the terminal members. The openings 138 are arranged in the same pattern as the openings 124 in the circuit board 120, e.g., symmetrically arranged about the center of the circuit hoard 130. Projections 126 extend from an upper surface 134 of the base 132 and may be arranged symmetrically about the center of the base. The projections 126 may be integrally formed with the circuit board 130 or constitute standoffs. The projections 136 may have a circular or polygonal cross-section. In one example, the projections 136 and openings 138 alternate around the outer extent of the base 132. In any case, when the electrical component 80 is assembled the projections 126 are configured to abut the underside of the circuit board 120.

Referring to FIG. 5, the terminal members 180 are made of electrically conductive material, such as copper or aluminum, and extend from a first end 182 to a second end 184. In one example, the first end 182 has a smaller cross-section than the second end 184. A shoulder 186 is positioned between the first and second ends 182, 184.

Referring to FIG. 7A, to assemble the electrical component 80 each terminal member 180 is passed through an opening 138 in the circuit hoard 130 and a corresponding opening 124 in the circuit board 120 until each shoulder 186 abuts the underside of the circuit board 120. The terminals members 180 are secured to the circuit boards 120, 130, e.g., via soldering, to electrically connect the terminal members to the circuit boards and sensor 200. The sensor 200 is configured to allow electricity to pass between the terminal members 180 when actuated and prevents electricity from passing between the terminal members when unactuated. The terminal members 180 thereby conduct the flow of electricity when the switch assembly 10 is in a closed circuit state.

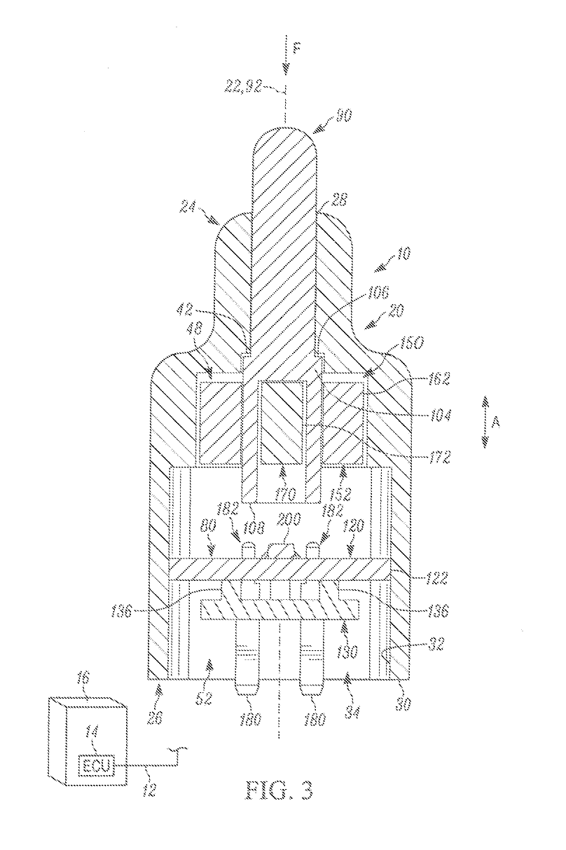

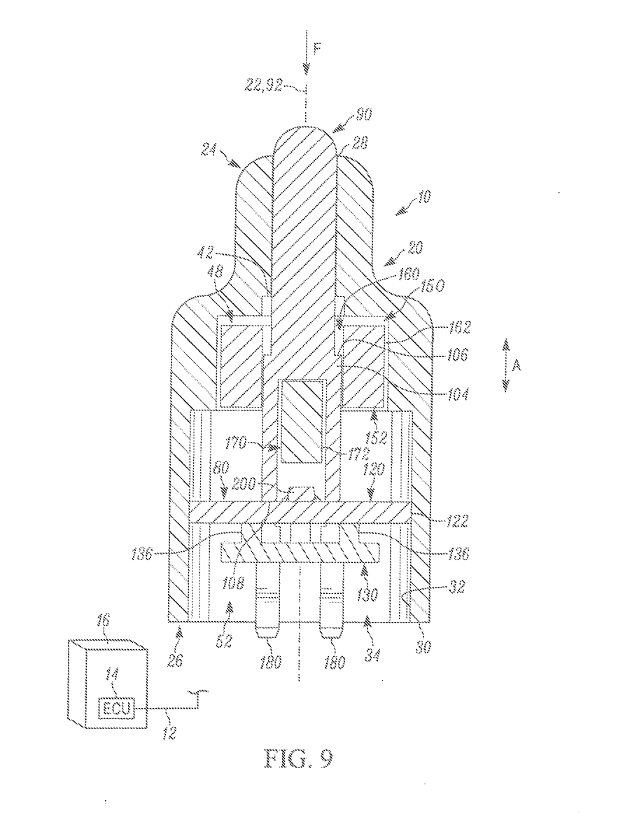

Stated another way, it should be appreciated by those skilled in the art that the slate of the switch assembly 10 changes by changing of fee location of the plunger 90 relative to the location of the sensor 200. That is, the switch assembly 10 in an alternative example embodiment, could conduct the flow of electricity between the terminal members 180 when the switch assembly and more specifically the plunger 90 is in an unactuated state (FIG. 3) or not conduct the flow of electricity between terminal members 180 when the switch assembly and more specifically the plunger 90 is in an actuated state (FIG. 9).

The circuit boards 120, 130 cooperate to secure and maintain the terminal members 180 in a particular spatial relationship relative to one another. As shown, the circuit boards 120, 130 help keep the terminal members 180 in a parallel relationship with one another and generally perpendicular to the circuit boards. The circuit boards 120, 130 also provide a protective barrier to the terminal members 180 to help ensure the terminal members are not bent, scratched or otherwise damaged during installation or use of the switch assembly 10.

Referring to FIG. 3, to assemble the switch assembly 10 the head 98 of the plunger 90 with the second member 170 secured thereto, is fed into the passage 34 at the second end 26 of the housing 20 and upwards along the axis 22 until the head extends out of the passage at the first end 24 of the housing. The first member 152 of the biasing device 150 is secured within the third portion 48 of the passage 34 adjacent the end surface 50 and encircling the body 100 of the plunger 90 and the second member 170.

The electrical component 80 is secured within the fourth portion 52 of the passage 34 with the first ends 182 of the terminal members 180 extending towards the plunger 90. To this end, the circuit board 120 is press-fit into the fourth portion 52 of the passage 34 of the housing 20. Alternatively, the circuit hoard 120 may be secured to the inner surface 32 within the fourth portion 52 using fasteners, a seal, gasket, other encapsulate, adhesive, etc. (not shown). In any case, securing the circuit board 120 to the housing 20 secures the entire electrical component 80 to the housing.

The terminal members 180 may extend out of the housing 20 or may be positioned entirely within the housing (not shown). Wire coupled or in communication with the wiring harness 12 is then connected to the terminal members 180 (not shown). At this time, a two-part epoxy (not shown) may be poured into the fourth portion 52 of the passage 34 around the electrical component 80 and solidified to hold the electrical component in position and provide an environmental seal near the attachment of the terminal members 80 to the wiring harness 12 (not shown).

The plunger 90 is movable along the axis 22 of the housing 20 within the passage 34 relative to the first member 152 of the biasing device 150 and the electrical component 80. In other words, the plunger 90 is movable with the second member 170 of the biasing device 150 towards and away from the sensor 200 on the circuit board 120 in the direction indicated generally by the arrow A in FIG. 3.

In one example, a portion of the inner surface 32 within the first portion 40 may provide a sealing/sliding surface for o-rings (not shown) provided on the plunger 90. The o-rings or seals provide an environmental seal with the housing 20 to prevent contaminates or debris from entering the passage 34 at the first end 24 of the housing.

The magnetic fields of the first and second members 152, 170 of the biasing device 150 are configured to bias the second member in an upward direction A along the axis 22 towards the first end 24 of the housing 20. Consequently, the plunger 90 secured to the second member 170 is biased upward in the direction A towards the first end 24 of the housing 20. The end surface 106 on the flange 104 of the plunger 90 abuts the end surface 42 of the housing 20 to limit upward movement of the plunger in the direction A.

The end surface 42 is positioned along the axis 22 of the housing 20

such that the second member 170 of the biasing device 150 is axially aligned with the first member 152 when the and surface 106 abuts the end surface 42. Consequently, the plunger 90 has an initial or resting position extending out of the housing 20 and abutting the end surface 42. In this position, the second member 170 is aligned with the first member 152, the flange 104 of the plunger 90 abuts the end surface 42, and the plunger is axially spaced from the sensor 200.

When an external force is applied to the head 98 of the plunger 90 in the direction F the plunger is urged downward along the axis 22 towards the electrical component 80. The plunger 90 moves downward in the direction A against the magnetic forces of the biasing device 150 until the end surface 108 abuts the circuit board 120, as shown in FIG. 9, thereby placing the plunger in a final or depressed position. This places the sensor 200 within fee passage 102 of the plunger 90 and places the second member 170 of the biasing device 150 in proximity to the sensor. Alternatively, the depressed plunger 90 may also abut the dividing wall of the housing 20, when present. In this construction, the magnetic field of the second member 170 is sufficient to pass through the housing 20 dividing wall. Regardless, in the depressed position, the plunger 90 is partially (or fully) retracted into the passage 34 and therefore extends out of the housing 20 a lesser degree than when the plunger is in the extended position.

When the plunger 90 is in the depressed position, the magnetic field of the second member 172 actuates the sensor 200. If the sensor 200 has a normally open configuration the depressed plunger 90 closes the electrical circuit through the switch assembly 10 and electrically connects the terminal members 180 to one another. This results in actuation or communication of the switch assembly 10 to the ECU 14 of the power equipment 16 or directly to the power equipment or components thereof. In other words, closing the electrical circuit allows for the passage of electricity from the wiring harness 12, up one or more of the terminal members 180, through the circuit board 120, and down one or more of the terminal members back into the wiring harness.

On the other hand, if the sensor 200 has a normally closed configuration, the depressed plunger 90 opens the electrical circuit through the switch assembly 10 to prevent electrical connectivity between the terminal members 180. In other words, opening the electrical circuit prevents the passage of electricity from the wiring harness 12, up one or more of the terminal members 180, through the circuit board 120, and down one or more of the terminal members back into the wiring harness.

So long as the external force F is maintained on the plunger 90 sufficient to maintain the end surface 108 in abutment with the circuit board 120, i.e., the plunger remains in the depressed position, the circuit will remain closed and electricity will flow through the switch assembly 10. Upon removal of the external force F from the plunger 90 the magnetic fields of the first and second members 152, 170 cooperate to draw the second member and, thus, draw the plunger upward in the direction A away from the electrical component 80 until the plunger abuts the end surface 42. This returns the plunger 90 to the initial position extending out of the housing 20 as shown in FIG. 3.

The design of the switch assembly 10 as described above fixedly attaches the terminal members 180 within the housing 20 such that the final location for all switch assemblies during construction are constant and repeatable within the housing. The design of the circuit boards 120, 130 and terminal members 180, and their respective interconnection, eliminates movement of the terminal members during installation and operation of the switch assembly 10. This is further illustrated as the plunger 90 is translated between the depressed position (see FIG. 9) and the extended position (see FIG. 3).

In the foregoing specification, specific embodiments have been described. However, one of ordinary skill in the art appreciates that various modifications and changes can he made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any elements) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus mat comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. In one non-limiting embodiment the terms are defined to be within for example 10%, in another possible embodiment within 5%, in another possible embodiment within 1%, and in another possible embodiment within 0.5%. The term “coupled” as used herein is defined as connected or in contact eit her temporarily or permanently, although not necessarily directly and not necessarily mechanically. A device or structure that is “configured” in a certain way is configured in at least that way, but may also be configured in ways that are not listed.

To the extent that the materials for any of the foregoing embodiments or components thereof are not specified, it is to be appreciated that suitable materials would be known by one of ordinary skill in the art for the intended purposes.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A switch assembly comprising:
a housing having a passage extending along a longitudinal axis;
a plunger positioned within the passage and movable along the axis relative to the housing between an extended position protruding a first axial distance out of the housing and a depressed position protruding a second axial distance out of the housing less than the first distance;
a magnetic biasing device for biasing the plunger towards the extended position, the magnetic biasing device including a first magnetic member secured to the housing and a second magnetic member secured to the plunger and movable with the plunger relative to the first magnetic member; and
an electrical component positioned within the passage and having a pair of terminal members and a sensor, movement of the plunger to the extended position placing the sensor in an unactuated condition to change the state of electricity from one of an open and a closed condition between the terminal members, movement of the plunger to the depressed position placing the sensor in an actuated condition to change the state of electricity from the other of an open and a closed condition between the terminals.

2. The switch assembly of claim 1, wherein at least one of the first magnetic member and the second magnetic member is a permanent magnet.

3. The switch assembly of claim 1, wherein at least one of the first magnetic member and the second magnetic member is an electromagnet.

4. The switch assembly of claim 1, wherein the first magnetic member includes a passage through which the plunger extends.

5. The switch assembly of claim 4, wherein the plunger includes a passage for receiving the second magnetic member.

6. The switch assembly of claim 1, wherein the first and second magnetic members are axially aligned with one another when the plunger is in the extended position and axially spaced from one another when the plunger is in the depressed position.

7. The switch assembly of claim 1, wherein the second magnetic member is cylindrical.

8. The switch assembly of claim 1, wherein the magnetic field of the biasing device biases the plunger into engagement with an axial end surface of the housing.

9. The switch assembly of claim 1, wherein the plunger, the first magnetic member, and the second magnetic member are concentric with one another and centered on the longitudinal axis of the housing.

10. The switch assembly of claim 1, wherein the sensor is a magnetic sensor and the magnetic field of the second magnetic member actuates the sensor.

11. The switch assembly of claim 1, wherein the sensor is placed in the actuated condition when the second magnetic member moves within a predetermined distance from the sensor and is placed in the unactuated condition when the second magnetic member is spaced beyond the predetermined distance from the sensor.

12. A switch assembly comprising;
a housing having a passage extending along a longitudinal axis;
a plunger positioned within the passage and movable along the axis relative to the housing between an extended position protruding a first axial distance out of the housing and a depressed position protruding a second axial distance out of the housing less than the first distance;
a magnetic biasing device for biasing the plunger towards the extended position, the magnetic biasing device including a first magnetic member secured to the housing and a second magnetic member secured to the plunger and movable with the plunger within and relative to the first magnetic member; and
an electrical component positioned within the passage and having a pair of terminal members and a sensor, movement of the plunger to the extended position placing the sensor in an unactuated condition to change the state of electricity from one of an open and a closed condition between the terminal members, movement of the plunger to the depressed position placing the sensor in an actuated condition to change the state of electricity from the other of an open and a closed condition between the terminals, the sensor switching between the actuated condition and the unactuated condition in response to the magnetic field of the second magnetic-member.

13. The switch assembly of claim 12, wherein at least one of the first magnetic member and the second magnetic member is a permanent magnet.

14. The switch assembly of claim 12, wherein at least one of the first magnetic member and the second magnetic member is an electromagnet.

15. The switch assembly of claim 12, wherein the first, magnetic member includes a passage through which the plunger extends.

16. The switch assembly of claim 15, wherein the plunger includes a passage for receiving the second magnetic member.

17. The switch assembly of claim 12, wherein the first and second magnetic members are axially aligned with one another when the plunger is in the extended position and axially spaced from one another when the plunger is in the depressed position.

18. The switch assembly of claim 12, wherein the second magnetic member is cylindrical.

19. The switch assembly of claim 12, wherein the magnetic field of the biasing device biases the plunger into engagement with an axial end surface of the housing.

20. A method for operating a switch assembly comprising:
providing a housing having a passage extending along a longitudinal axis;
positioning a plunger within the passage, the plunger being movable along the axis relative to the housing between an extended position protruding a first axial distance out of the housing and a depressed position protruding a second axial distance out of the housing less than the first distance;
positioning a magnetic biasing device within the passage for biasing the plunger towards the extended position, the magnetic biasing device including a first magnetic member secured to the housing and a second magnetic member secured to the plunger and movable with the plunger relative to the first magnetic member;
positioning an electrical component within the passage, the electrical component having a pair of terminal members and a sensor, movement of the plunger to the extended position placing the sensor in an unactuated condition to change the state of electricity from one of an open and a closed condition between the terminal members, movement of the plunger to the depressed position placing the sensor In an actuated condition to change the state of electricity from the other of an open and a closed condition between the terminals;
depressing the plunger towards the electrical component against the bias of the magnetic biasing device to place the sensor in the actuated condition.
